(19) United States
(12) Patent Application Publication
(10) Pub. No.: US 2012/0306697 A1
(43) Pub. Date: Dec. 6, 2012

(54) PHASED-ARRAY ANTENNA AND PHASE CONTROL METHOD THEREFOR

(76) Inventors: Tomohisa Kimura, Tokyo (JP); Kenichi Amma, Tokyo (JP); Nobuhiko Fukuda, Tokyo (JP)

(21) Appl. No.: 13/579,693

(22) PCT Filed: Feb. 22, 2011
(86) PCT No.: PCT/JP2011/053775

§ 371 Date: Aug. 17, 2012

(30) Foreign Application Priority Data
Feb. 22, 2010 (JP) 2010036298

(51) Int. Cl. H01Q 3/30; H01Q 21/06

(52) U.S. Cl. 342/368

(57) ABSTRACT

The precision of phase correction is improved. Provided are a detection unit (40) that detects a phase of arrival of a pilot signal at each of antenna panel on the basis of the pilot signal and a reference signal commonly transmitted to each antenna panel; a position specifying unit (51) that specifies a position of each of the antenna panels relative to a reference panel defined as an antenna panel for reference among the plurality of the antenna panels, on the basis of the phase of arrival and an angle of arrival formed between the direction of arrival of the pilot signal and the antenna panel; and a phase-shift setting unit (52) that sets respective phase shifts for the signals radiated from individual antenna elements on the basis of information about the positions of the antenna panels specified by the position specifying unit (51).

### TECHNICAL FIELD

The present invention relates to a phased-array antenna employed in, for example, an SSPS (Space Solar Power System), and more particularly, to a phased-array antenna that can control the beam direction of electrical power transmission to a receiving facility with high precision, and a phase control method therefor.

### BACKGROUND ART

With increasing carbon dioxide emissions due to the use of fossil fuels, environmental problems such as global warming and energy problems such as depletion of fossil fuels have been looming in recent years. Therefore, there have been growing demands for clean energy year on year, and SSPS schemes are seen as one way of solving these problems.

In an SSPS scheme, as shown in FIG. 9, an artificial satellite equipped with a gigantic solar panel is launched into equatorial orbit, and the electrical power generated from sunlight is converted into microwaves 100 by a transmitter module in the solar panel. Then, the microwaves 100 are transmitted from a microwave power transmitter 101 to a power receiving facility 102 provided on the ground, and they are converted back to electrical power again on the ground for use.

Accordingly, it is possible to stably supply clean energy without any influence from the weather or time zone, which are drawbacks of solar power generation. Some of the technical hurdles in implementing this scheme are high-capacity electrical power transmission, microwave beam control, reducing running costs, and so forth, and one method that has been proposed for satisfying these requirements is to use a laminated active integrated antenna (Active Integrated Antenna: AIA) in the microwave power transmitter 101. To achieve even higher efficiency in power transmission, one of the things that is being investigated is building a retrodirective function into the laminated active integrated antenna.

The retrodirective function is a function in which a pilot signal (guidance signal) sent from the power receiving facility 102 provided on the ground is received by a power-transmission antenna provided in the microwave power transmitter 101, and phase information about the received pilot signal is reflected in the transmitted waves radiated from the power-transmission antenna, so that the transmitted waves are directed in the direction of arrival of the pilot signal.

At the power-transmission antenna in the SSPS, 1 m square antenna panels that are two-dimensionally arrayed are connected at respective nodes to construct a large-area antenna. Because the large-area antenna is bent centered on the nodes, the phase-fronts of the microwaves radiated from the individual antenna panels differ, and unnecessary waves with a high power level are radiated to locations other than the target; therefore, methods for placing the phase-fronts in step have been proposed.

For example, Patent Literature 1 discloses an example of a retrodirective function in which the distance between each antenna element and an antenna reference line perpendicular to the direction of arrival of the pilot signal is calculated on the basis of an angle of arrival, formed between the antenna panels and the direction of arrival of the pilot signal, and phase shifts of the microwaves to be radiated from the individual antenna elements are set and corrected according to the respective calculated distances.

### CITATION LIST

### Patent Literature

{PTL 1} Japanese Unexamined Patent Applications, Publication No. 2006-287451

### SUMMARY OF INVENTION

### Technical Problem

However, in the method in Patent Literature 1, with a panel serving as a reference set as the origin, the phase shifts of neighboring panels are set and corrected in turn; therefore, in cases including estimation errors in the positions of the previously connected antenna panels, when these estimation errors are included, there is a problem in that the phase error gradually adds up, and the phase correction precision decreases at panels farther away from the reference panel.

The present invention has been conceived in light of such circumstances, and an object thereof is to provide a phased-array antenna that can improve the phase correction precision, as well as a phase control method therefor.

### Solution to Problem

To solve the problems mentioned above, the present invention employs the following solutions.

A first aspect of the present invention is a phased-array antenna which has a configuration in which a plurality of antenna panels, having a plurality of antenna elements disposed in an array, are connected in the form of a straight line or a plane and which radiates a signal in a direction of arrival of a pilot signal transmitted from a receiving facility by controlling phases of signals input to and output from the individual antenna elements, the phased-array antenna including a detection unit that detects a phase of arrival of the pilot signal at each of the antenna panels on the basis of the pilot signal and a reference signal that is commonly transmitted to each of the antenna panels; a position specifying unit that specifies a position of each of the antenna panels relative to a reference panel defined as the antenna panel for reference among the plurality of the antenna panels, on the basis of the phase of arrival and an angle of arrival between the direction of arrival of the pilot signal and the antenna panel; and a phase-shift setting unit that sets respective phase shifts for the signals radiated from the individual antenna elements on the basis of information about the positions of the antenna panels specified by the position specifying unit.

With the configuration described above, the pilot signal and the reference signal commonly transmitted to the antenna panels are received at each antenna panel. The phase of arrival of the pilot signal, detected based on the pilot signal and the reference signal, and the angle of arrival formed between the antenna panels and the direction of arrival of the pilot signal are obtained. Then, to obtain the position of each antenna panel, a prescribed reference panel is selected, and the positions of the individual antenna panels with respect to this reference panel are estimated on the basis of the phases of arrival and the angles of arrival. Phase shifts for the signals radiated from the individual antenna elements are set on the basis of information about the positions of the antenna panels with respect to the reference panel, estimated in this way.

Accordingly, because the positions of the individual antenna panels are estimated with reference to the pilot signal detected at the respective antenna panels, no estimation error in the positions of the plurality of previously connected antenna panels is included. Therefore, it is possible to improve the precision of phase correction between the antenna panels.

An instruction sending unit which is disposed at a prescribed height above a surface of the reference panel in the phased-array antenna described above and which sends the reference signal to each of the antenna panels may be provided.

By transmitting the reference signal from the instruction sending unit located a prescribed height above the surface of the reference panel, the difference in arrival distances of the reference signal up to the most distant antenna panel from the reference panel is reduced compared with a case where the instruction sending unit is located on the surface of the reference panel. Accordingly, the reference signal detection error at each antenna panel can be reduced.

An instruction sending unit which is disposed on a surface of at least one of the antenna panels of the plurality of the antenna panels in the phased-array antenna described above and which sends the reference signal to each of the antenna panels; and a control unit that controls the timing at which the reference signal is detected at the other antenna panels other than the antenna panel having the instruction sending unit according to a distance between the antenna panel having the instruction sending unit and the other antenna panels may be provided

Because the instruction sending unit is located on the antenna panel surface, the distances between that antenna panel and other antenna panels are known in advance, and therefore, by controlling the timing at which the reference signal is detected according to these distances, it is possible to reduce the reference signal transfer error.

The position specifying unit of the phased-array antenna described above may include a selection unit that selects the next antenna panel at which the antenna panel positions is to be specified, and the selection unit may sequentially select a plurality of the antenna panels neighboring the antenna panel where position determination is completed.

If the antenna panels are, for example, quadrangles, there are four neighboring antenna panels in four directions. If the four antenna panels neighboring an antenna panel whose position has been specified by the position specifying unit are selected as antenna panels where position specifying processing is to be performed next, the next position specifying processing is performed in parallel in the four selected antenna panels. Accordingly, because the positions of the antenna panels are sequentially specified in parallel on the basis of the position information of the neighboring antenna panel, it is possible to reduce the processing time required for specifying the positions of the antenna panels.

In the phased-array antenna described above, a plurality of the reference panels may be provided by dividing the antenna panels into a plurality of areas and having respective reference panels in the individual areas, with a reference panel serving as a primary reference among the plurality of the reference panels being defined as a first reference panel, and the reference panels other than the first reference panel being defined as second reference panels; and in each of the areas, the position specifying unit may specify the positions of the antenna panels on the basis of the reference panel in the area, and at boundaries between neighboring areas, with the area having the first reference panel or the area close to the area having the first reference panel defined as having superiority, and the area which does not have superiority over the neighboring area being defined as having inferiority, may correct the positions of the antenna panels in the area having inferiority on the basis of the neighboring reference panel having superiority.

Thus, by having a reference panel in each divided area, a plurality of reference panels are provided in the phased-array antenna. Also, because the positions of the antenna panels are specified based on the reference panel in each area, parallel processing becomes possible, and the time required for the processing can be shortened.

A second aspect of the present invention is a phase control method for a phased-array antenna which has a configuration in which a plurality of antenna panels, having a plurality of antenna elements disposed in an array, are connected in the form of a straight line or a plane and which radiates a signal in a direction of arrival of a pilot signal transmitted from a receiving facility by controlling phases of signals input to and output from the individual antenna elements, the phase control method for a phased array antenna including a first step of detecting a phase of arrival of the pilot signal at each of the antenna panels on the basis of the pilot signal and a reference signal that is commonly transmitted to each of the antenna panels; a second step of estimating a position of each of the antenna panels relative to a reference panel defined as the antenna panel for reference among the plurality of the antenna panels, on the basis of the phase of arrival and an angle of arrival between the direction of arrival of the pilot signal and the antenna panel; and a third step of setting respective phase shifts for the signals radiated from the individual antenna elements on the basis of information about the positions of the antenna panels specified in the second step.

### Advantageous Effects of Invention

The present invention affords an advantage in that phase correction precision can be improved and phase correction speed can be increased.

### BRIEF DESCRIPTION OF DRAWINGS

FIG. 1 is a diagram showing arrays of antenna panels and antenna elements in a phased-array antenna according to a first embodiment of the present invention.

FIG. 2 is a block diagram showing the electrical configuration of the phased-array antenna according to the first embodiment of the present invention.

FIG. 3 is a diagram showing an extracted view of part of the phased-array antenna shown in FIG. 1.

FIG. 4 is an operating flow showing the processing order of various processes executed by a detection unit and a computational processing unit.

FIG. 5 is a diagram showing the effects of the phased-array antenna according to the first embodiment of the present invention.

FIG. 6 is a diagram for explaining the order in which the antenna panels are selected by the selection unit of the phased-array antenna according to a second embodiment of the present invention.

FIG. 7 is a enlarged view showing antenna panels extracted from the vicinity of a first specifying panel.

FIG. 8 is a diagram for explaining the order of determining the panel positions of a phased-array antenna according to a third embodiment of the present invention.

FIG. 9 is an explanatory diagram showing a space solar power system.

### DESCRIPTION OF EMBODIMENTS

Embodiments of a phased-array antenna and a phase control method therefor according to the present invention will be described below with reference to the drawings.

### First Embodiment

A description will be given below of an example case in which a phased-array antenna according to the present invention is applied to an SSPS.

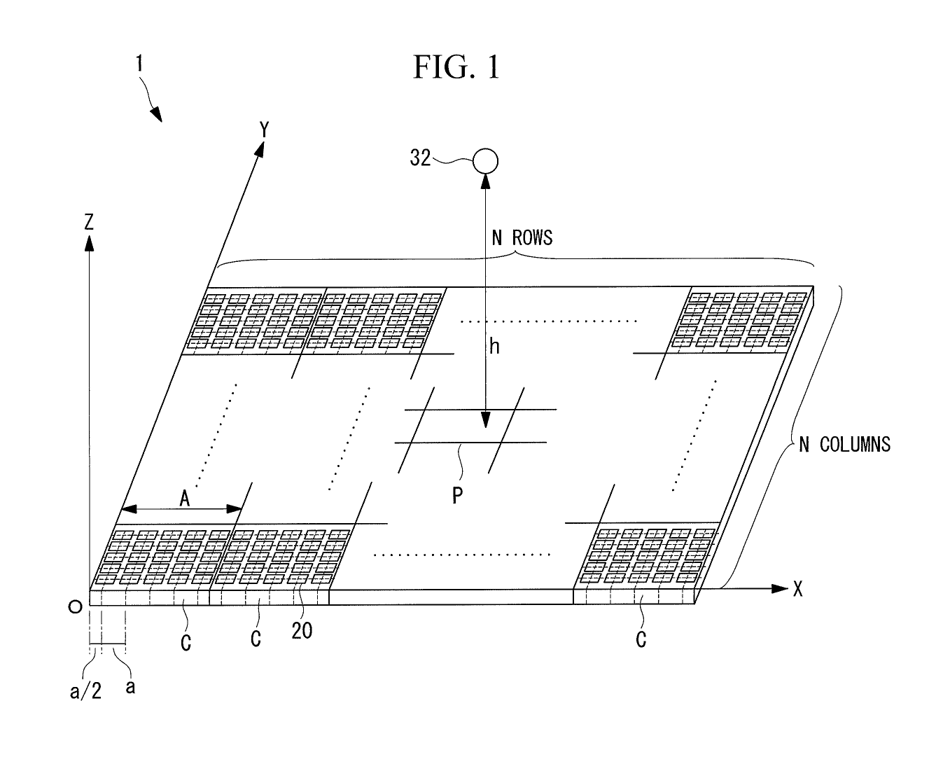

FIG. 1 is a diagram showing, in outline, the configuration of a phased-array antenna 1 according to this embodiment. As shown in FIG. 1, the phased-array antenna 1 according to this embodiment includes a plurality of antenna panels C arrayed two-dimensionally in N rows by N columns on an X-Y plane in an O-XYZ orthogonal coordinate system. Neighboring antenna panels C are joined at respective nodes (not shown). Each antenna panel C is, for example, a square of side length A (for example, about 1 m), and the phased-array antenna 1, which is large at approximately 2 km across with all panels, is constructed by joining such antenna panels C together.

In each antenna panel C, a plurality of antenna elements 20 are two-dimensionally arrayed at predetermined intervals in the X-axis direction and the Y-axis direction. For example, in each antenna panel C, the antenna elements 20 are two-dimensionally arrayed so that the intervals therebetween in the X-axis direction and the Y-axis direction are both a. The distances between the end faces of the antenna panels C and the antenna elements 20 closest to those end faces are all a/2.

As shown in FIG. 1, of the plurality of antenna panels C included in the phased-array antenna 1, when an antenna panel C used as a reference is defined as a reference panel P, an instruction sending unit 32 is provided at a position a predetermined height h above the surface of the reference panel P. The instruction sending unit 32 sends a time synchronizing pulse to each antenna panel C in the phased-array antenna 1 via wireless communication.

The height position h at which the instruction sending unit 32 is provided is preferably set so that a phase error calculated on the basis of a difference in arrival distances of the time synchronizing pulse between the reference panel P and each of the other antenna panels C other than the reference panel P falls within a prescribed range. The height position h at which the instruction sending unit 32 is provided is not particularly limited but, in this embodiment, is set to a position about 1 kilometer above the surface of the reference panel P because, as the distance (height) from the surface of the reference panel P increases, the difference in arrival distances of the time synchronizing pulse between the reference panel P and each of the other antenna panels C becomes shorter.

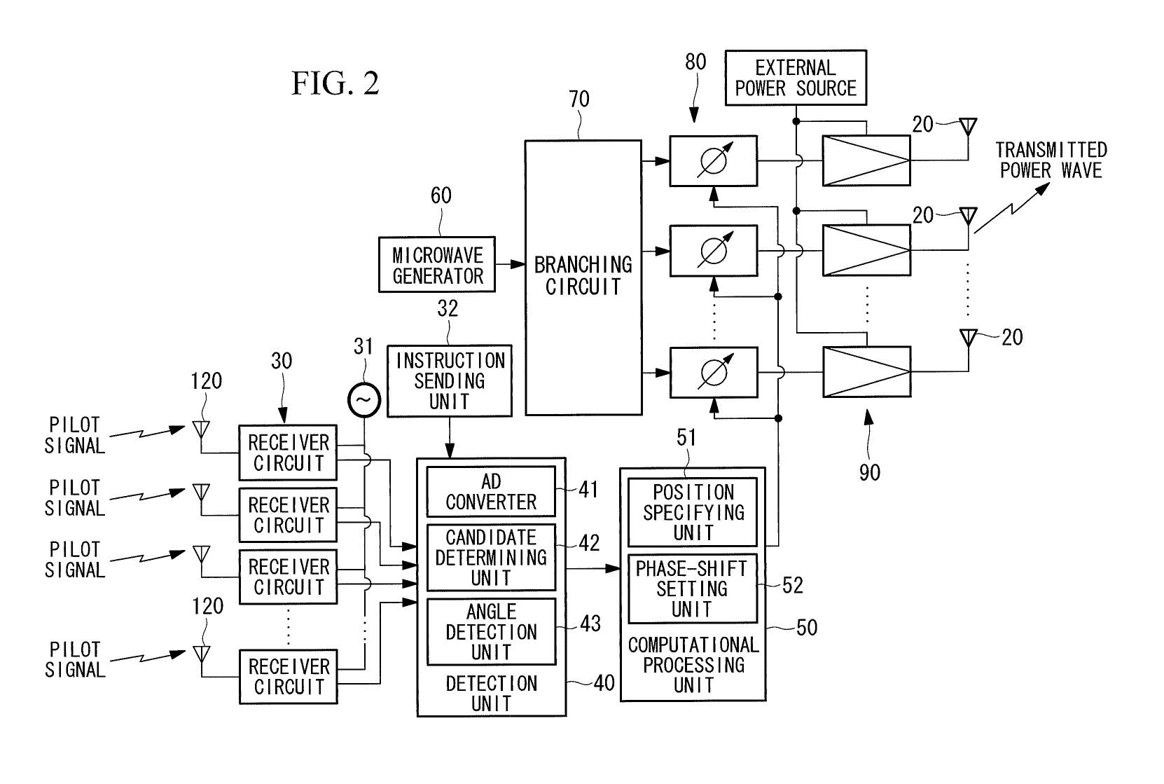

Next, the electrical configuration of the phased-array antenna 1 according to this embodiment will be described with reference to FIG. 2. FIG. 2 is a block diagram showing the electrical configuration of the phased-array antenna 1 according to this embodiment. In this diagram, the same parts as those shown in FIG. 1 are assigned the same reference signs.

A power source 31 sends to each antenna panel C, via wireless communication, a reference signal f_{p+Δp} serving as a reference for the case where a phase of arrival φ between each panel is estimated by a detection unit 40. A method that can be used by the power supply 31 to send the reference signal is described in detail, for example, in Japanese Unexamined Patent Application, Publication No. 2004-325162. By employing this known technology, it is possible to send the reference signal from the power source 31.

The instruction sending unit 32 outputs a pulse for synchronizing time (time synchronizing pulse) to the detection unit 40.

A receiver circuit 30, provided in each antenna panel C, downconverts a pilot signal fₚ received by a receiving antenna element 120 in each antenna panel C on the basis of the reference signal f_{p+Δp}, which should be set to a prescribed frequency, and outputs a downconverted pilot signal fₚ′ (=f_{Δp}=f_{p+Δp}−fₚ) to the detection unit 40. Here, the prescribed frequency is a frequency such that the size of the antenna falls within a prescribed range. Even though the pilot signal fₚ is downconverted, a relative phase of the pilot signal fₚ received at the receiver circuit 30 in each antenna panel is maintained.

The detection unit 40 detects, at the antenna panels C, an angle of arrival e, formed between the antenna panel surface and the direction of arrival of the pilot signal, and a phase of arrival φ of the pilot signal at the antenna panel C, for each antenna panel, and outputs them to a computational processing unit 50. Specifically, the detection unit 40 includes an A/D converter 41, a candidate determining unit 42, and an angle detection unit 43.

With the time synchronizing pulse obtained from the instruction sending unit 32 serving as a trigger, the AD converter 41 outputs to the candidate determining unit 42 timing information for detecting the phase of arrival φ of the pilot signal fₚ′ downconverted in the receiver circuit 30 of each antenna panel C.

The candidate determining unit 42 detects the phase of arrival φ of the pilot signal fₚ′ at each antenna panel C on the basis of the pilot signal fₚ′ downconverted based on the reference signal f_{p+Δp} and the timing information obtained from the A/D converter 41. In other words, the candidate determining unit 42 detects the phase of arrival φ of the pilot signal fₚ′ using the position of the reference signal at the instant the timing information is received. The candidate determining unit 42 estimates a candidate R for the position of the antenna panel C (hereinafter referred to as “panel position”) on the basis of the phase of arrival φ of the pilot signal fₚ, for each antenna panel C. The candidates R for the position of the antenna panel are position candidates which are integer multiples of the wavelength. The candidate determining unit 42 outputs the phase of arrival φ and the panel position candidate R to the computational processing unit 50.

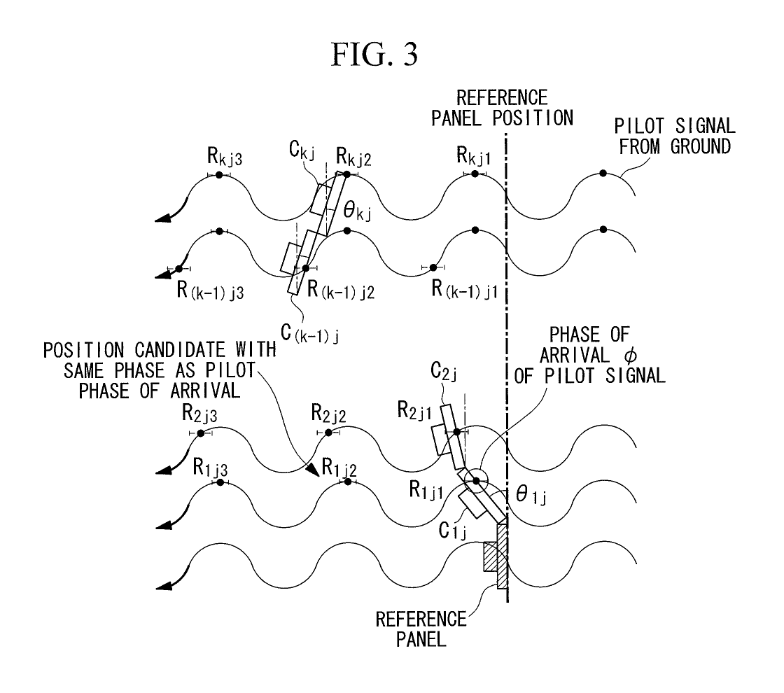

FIG. 3 shows a plurality of antenna panels C receiving a pilot signal from the ground. For example, the candidate determining unit 42 detects that the pilot signal fₚ is received at the peak of the waveform on the basis of information about the phase of arrival φ₁ⱼ of the pilot signal fₚ at an antenna panel C₁ⱼ neighboring the reference panel P and estimates R₁ⱼ₁, R₁ⱼ₂, and R₁ⱼ₃, where the phase of the pilot signal fₚ is successively shifted by 360°, as the panel position candidates R.

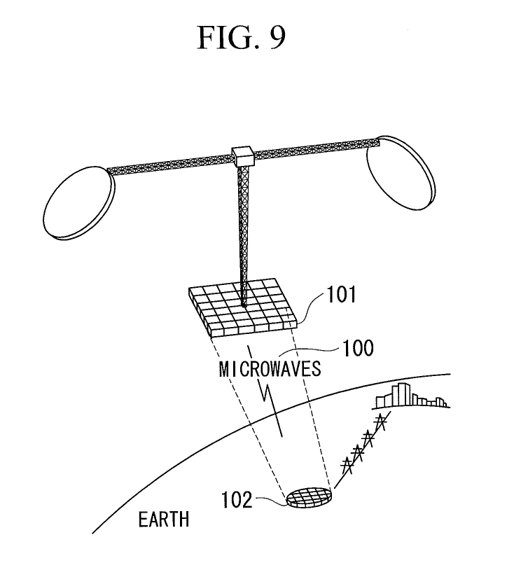

The angle detection unit 43 includes an RF interferometer and determines the direction of a power receiving facility 102 (for example, see FIG. 9) that sent the pilot signal by measuring phase differences of the pilot signal fₚ received by the plurality of receiving antenna elements 120 provided in each antenna panel C. For each antenna panel C, the angle detection unit 43 estimates an angle of arrival θ indicating the direction of the receiving facility 102 and outputs it to the computational processing unit 50.

The computational processing unit 50, which is equipped with a microcomputer, calculates phase shifts for the microwaves emitted from the individual antenna elements 20 by executing phase control processing, described later, on the basis of the angles of arrival θ, the phases of arrival φ, and the panel position candidates R and outputs them to respective tunable phase shifters 80. More specifically, the computational processing unit 50 includes a position specifying unit 51 and a phase-shift setting unit 52.

For the plurality of antenna panels, the position specifying unit 51 specifies the position of each antenna panel relative to the reference panel P on the basis of the phases of arrival φ and the angles of arrival θ. Also, the reference panel P is set to be stationary.

Here, a case where the position of the antenna panel C₁ⱼ immediately neighboring the reference panel P is estimated will be described as an example. Among the panel position candidates R (for example, R₁ⱼ₁, R₁ⱼ₂, R₁ⱼ₃) estimated when the phase of arrival φ₁ⱼ of the antenna panel C₁ⱼ is obtained, the position specifying unit 51 selects the panel position that corresponds to the position having the angle of arrival θ₁ⱼ from the position of the reference panel P and specifies the selected panel position R₁ⱼ₁ as the position of the antenna panel C₁ⱼ.

The position specifying unit 51 specifies the panel positions of the antenna panels C in this way and outputs information about the panel positions to the phase-shift setting unit 52. Here, the errors in the angles of arrival θ of the antenna panels are smaller than the wavelength.

The phase-shift setting unit 52 sets the phase shifts of the signals radiated from the individual antenna elements 20 on the basis of the panel position information specified by the position specifying unit 51. For example, in the case where the phase-shift setting unit 52 has acquired the specified panel position information, and the phase shift has been set for the neighboring antenna panel C closer to the reference panel P than the antenna panel C for which the phase shift is to be set, the phase shift of the power-transmission microwaves emitted from the antenna element 20 is set on the basis of the phase shift of that neighboring antenna panel C. Once the phase-shift setting unit 52 sets the phase shifts of the power-transmission microwaves, it outputs the phase shift information to the tunable phase shifters 80 corresponding to the respective antenna panels C.

On the other hand, a microwave generator 60 creates a reference microwave signal and outputs it to a branching circuit 70. The branching circuit 70 branches the reference microwave signal input thereto and outputs it to the tunable phase shifters 80 provided in association with the individual antenna elements 20.

The tunable phase shifters 80 each produce a phase shift in the microwaves having the reference phase shift input from the branching circuit 70 on the basis of the respective phase shift information input from the computational processing unit 50 and output the phase shifts to power amplifiers 90.

The power amplifiers 90, which are provided in association with the respective antenna elements 20, amplify the electrical power supplied by an external power source (a space solar power generator) on microwaves at the phases and frequencies of the signals output from the tunable phase shifters 80 and output them to the antenna elements 20.

The antenna elements 20 radiate the power-amplified microwaves having the respective phases towards the power receiving facility 102 (see FIG. 9).

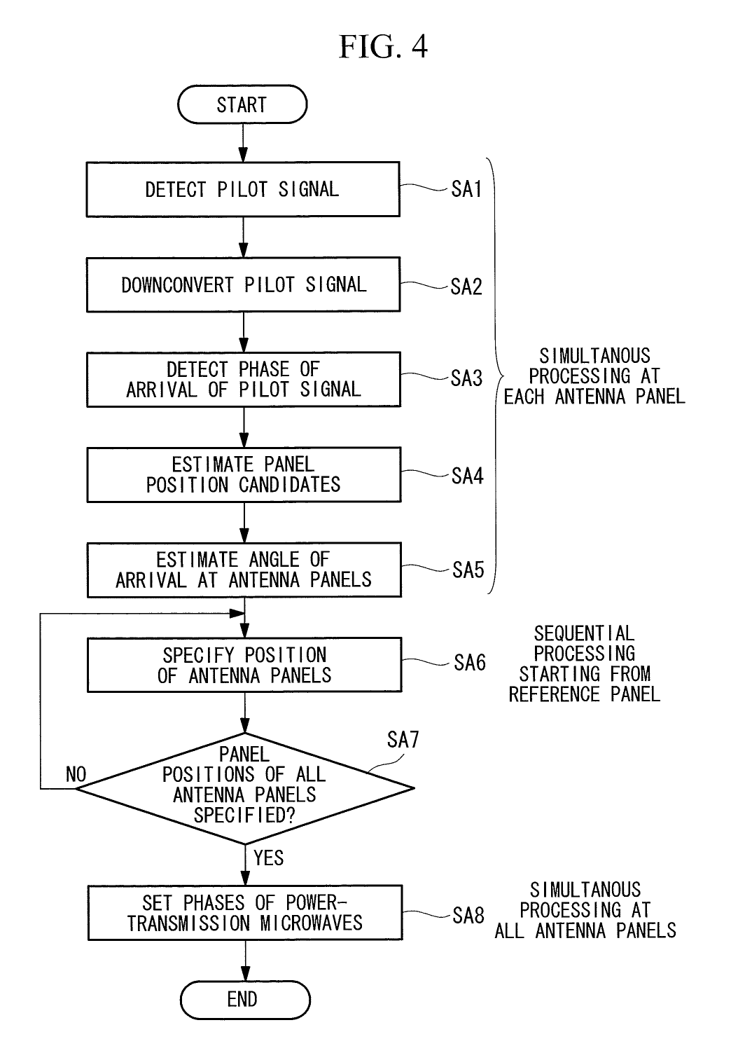

Next, the phase control processing performed by the computational processing unit 50 described above will be described using FIG. 4. In the following description, i and j are numbers indicating the positions of the panels, where i is a row number (i=1 to k), and j is a column number (j=1 to n), and in row j, the antenna panel neighboring the reference panel P is defined as antenna panel C₁ⱼ, and the top-most antenna panel is defined as antenna panel Cᵢⱼ. FIG. 3 shows the antenna panels C₁ⱼ, C₂ⱼ, . . . , C₍ₖ₋₁₎ⱼ, Cₖⱼ disposed in row 1, row 2, row (k−1), and row k, as counted from the reference panel P, extracted as an example from the antenna panels C₁ⱼ to Cᵢⱼ in column j.

The pilot signal fₚ is received by the respective receiving antenna elements 120 of the antenna panels C₁ⱼ to Cₖⱼ and is detected by the receiver circuits 30 (Step SA1 in FIG. 4). In the receiver circuits 30, the pilot signal fₚ is downconverted by the input reference pilot signal f_{p+Δp} from the power source 31 and is output to the detection unit 40 (Step SA2 in FIG. 4). In the candidate determining unit 42, for each of the antenna panels C₁ⱼ to Cₖⱼ, the phase of arrival φ of the downconverted pilot signal f_{Δp} is detected on the basis of the time synchronization pulse input from the instruction sending unit 32 via the A/D converter 41 (Step SA3 in FIG. 4), and based on this phase of arrival φ, the panel position candidates R for each of the antenna panels C₁ⱼ to Cₖⱼ are estimated (Step SA4 in FIG. 4).

In the angle detection unit 43, the angles of arrival θ of the pilot signals at the antenna panels C₁ⱼ to Cₖⱼ are estimated on the basis of the pilot signal fₚ obtained by the respective plurality of receiving antenna elements 120 of the antenna panels C₁ⱼ to Cₖⱼ (Step SA5 in FIG. 4). The position of each of the antenna panels C₁ⱼ to Cₖⱼ is specified on the basis of the above phase of arrival φ and angle of arrival θ (Step SA6 in FIG. 4). It is then determined whether or not the panel positions of all of the antenna panels C₁ⱼ to Cₖⱼ have been specified (Step SA7 in FIG. 4).

If the panel positions have been specified for all of the antenna panels, the phase shifts of the output power-transmission microwaves are set for the respective antenna panels C₁ⱼ to Cₖⱼ (Step SA8 in FIG. 4), whereupon this processing is completed. If all panel positions have not been specified, the process returns to step SA6, and the processing is repeated.

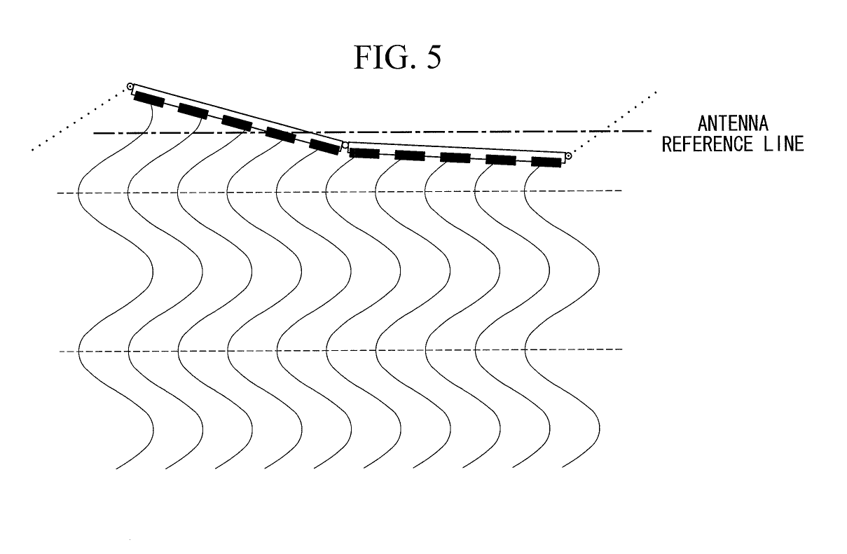

By detecting the phase of arrival φ of the pilot signal fₚ in each antenna panel and performing the phase control processing on the basis of the phase of arrival φ in this way, as shown in FIG. 5, the phase-fronts of the microwaves output from all of the antenna elements 20 disposed in all of the antenna panels C₁ⱼ to Cₖⱼ can be placed in step.

In the phase control processing in this embodiment, it is assumed that the phase setting (step SA8) based on the phase of arrival φ is performed at the stage where all panel positions have been specified in Step SA7 in FIG. 4; however, the phase control timing is not limited thereto. For example, the phase setting (Step SA8) may be performed sequentially in the order of the antenna panels whose panel positions are specified in Step SA6 in FIG. 4.

As described above, with the phased-array antenna 1 and phase control method therefor according to this embodiment, the phase of arrival φ of the pilot signal, detected on the basis of the pilot signal received at each antenna panel and the reference signal, and the angle of arrival θ between the antenna panel C and the direction of arrival of the pilot signal are obtained. Then, to obtain the position of each antenna panel C, a predetermined reference panel P is selected, and the respective positions of the individual antenna panels C with respect to this reference panel P are estimated on the basis of the phases of arrival φ and the angles of arrival θ. The phase shifts of the signals radiated from the individual antenna elements 20 are set on the basis of the position information of the antenna panels C with respect to the reference panel P which are estimated in this way.

Thus, because the position of each antenna panel C is estimated for each antenna panel C with reference to the pilot signal which the antenna panels C detect, it does not contain any estimation error in the positions of the plurality of previously connected antenna panels C. Therefore, it is possible to improve the precision of phase correction between the antenna panels C. In addition, by downconverting the pilot signal to a frequency at which the size of the antennas falls within a prescribed range, the wavelength of the pilot signal is increased, and the interval between panel position candidates estimated using the phase of arrival φ becomes wider. Thus, it is possible to improve the precision of panel position estimation.

By transmitting the reference signal from the instruction sending unit 32 which is located the prescribed height h above the surface of the reference panel P, compared with a case where the instruction sending unit 32 is located on the surface of the reference panel P, the difference in arrival distances of the reference signal up to the antenna panel C that is most distant from the reference panel P becomes small. By doing so, the detection error of the reference signal between individual antenna panels can be reduced, which allows phase correction to be performed with superior precision.

In this embodiment, the time difference at which each antenna panel receives the time synchronizing pulse is reduced by providing the instruction sending unit 32 at a location a prescribed height h above the surface of the antenna panels C; however, the position at which the instruction sending unit 32 is located is not limited thereto. For example, an instruction sending unit 32′ (not shown in the drawings) may be provided on the surface of the antenna panels C. If the instruction sending unit 32′ is provided on the surface of the antenna panels C, the distance between an antenna panel Cx having the instruction sending unit 32′ and another antenna panel Cy, other than the antenna panel Cx having the instruction sending unit 32′, is known in advance; therefore, a control unit (not shown in the drawings) for controlling the timing at which the reference signal is detected according to the distance between the antenna panel Cx and the other antenna panel Cy is provided in the other antenna panel Cy. Thus, the transfer error of the reference signal can be reduced by controlling the timing at which the reference signal is detected according to the distance between the antenna panel Cx having the instruction sending unit 32′ and the other antenna panel Cy, and the phase correction precision can thus be improved.

### Second Embodiment

Next, a phased-array antenna according to a second embodiment of the present invention will be described.

The phased-array antenna according to this embodiment differs from that in the first embodiment described above in that it is further provided with a selection unit for selecting the next antenna panel for specifying the antenna panel position with the position estimating unit 51. In the following, for the phased-array antenna according to this embodiment, a description of commonalties with the first embodiment will be omitted, and mainly the differences will be described.

The selection unit (not shown in the drawings) sequentially selects a plurality of antenna panels neighboring an antenna panel whose panel position has been specified as the antenna panels whose panel positions are to be specified next. For example, in the case where each antenna panel is a quadrangle, four antenna panels neighbor each antenna panel in four directions. Here, with the antenna panel where panel position specifying processing is initially performed being defined as a first specifying panel in the position specifying unit 51, after the position of the first specifying panel is determined, the selection unit selects the four antenna panels neighboring the antenna panel whose position is already specified as antenna panels where the panel position specifying processing is to be performed next.

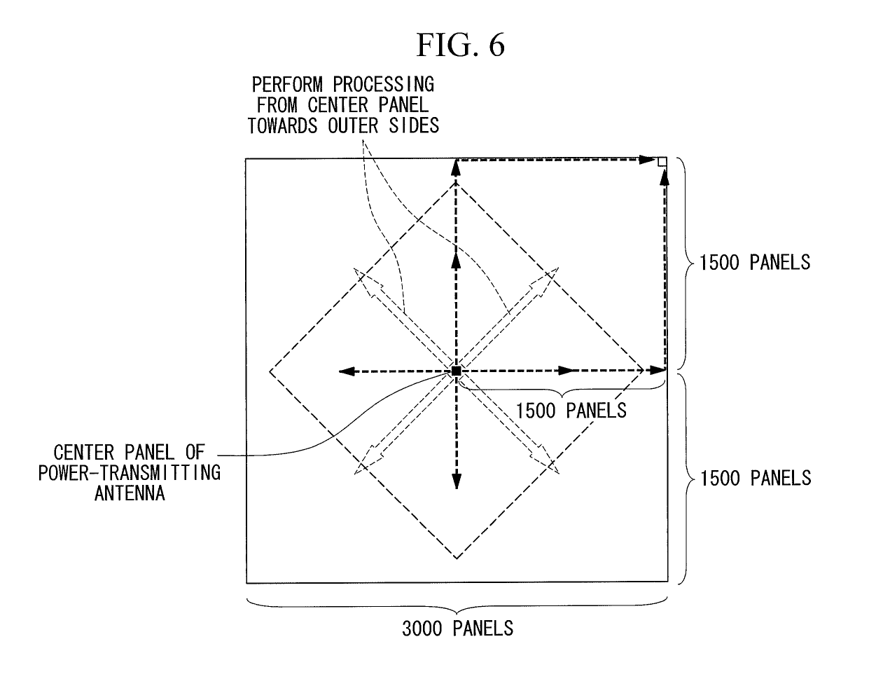

More preferably, as shown in FIG. 6, an antenna panel located substantially at the center of the phased-array antenna is selected as the first specifying panel. Accordingly, it is possible to shorten the time required for the panel position specifying processing. For example, if 3000 antenna panels are disposed in each of the vertical and horizontal directions, with the antenna panel located substantially at the center of the phased-array antenna defined as the first specifying panel, the panel position specifying processing is performed in parallel for 1500 panels in the four directions vertically and horizontally. At this time, the number of processing steps needed until the panel positions of the antenna panels that are most distant from the first specifying panel are specified is approximately 3000. Thus, it is possible to reduce the number of processing steps compared with a case where the first specifying panel is selected as an antenna panel located at an edge of the phased-array antenna (for example, approximately 6000 processing steps).

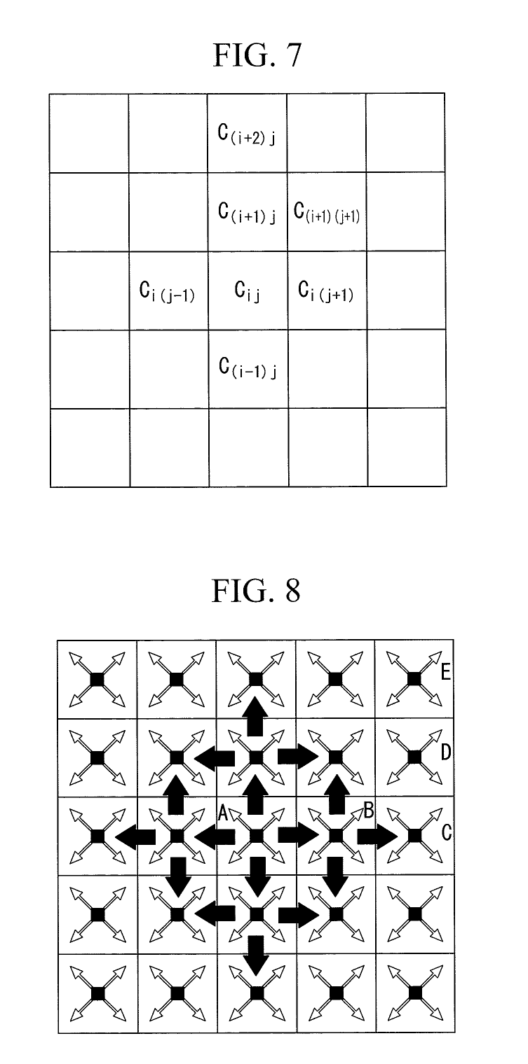

FIG. 7 in enlarged view of antenna panels extracted from the vicinity of the first specifying panel.

For example, if the center panel Cᵢⱼ in the phased-array antenna is defined as the first specifying panel, after the position of the center panel Cᵢⱼ is specified, the selection unit selects the four neighboring antenna panels C₍ᵢ₋₁₎ⱼ, C₍ᵢ₊₁₎ⱼ, Cᵢ₍ⱼ₋₁₎, and Cᵢ₍ⱼ₊₁₎ as the antenna panels whose positions are to be specified next. Also, after the panel positions of the selected antenna panels described above (for example, the antenna panel C₍ᵢ₊₁₎ⱼ which is one of the four antenna panels described above) are specified, the selection unit selects two neighboring ones (for example, antenna panels C₍ᵢ₊₂₎ⱼ and C₍ᵢ₊₁₎₍ⱼ₊₁₎ as antenna panels whose positions are to be specified next. Thus, the antenna panels are selected two-at-a-time or four-at-a-time by the selection unit, and the panel position specifying processing is performed in parallel.

The phase-shift setting unit 52 sets a phase shift for each antenna panel on the basis of the position information of each antenna panel specified by the parallel processing for the panel positions as described above.

In this way, because the plurality of antenna panels neighboring the antenna panel whose position has been specified and whose positions are not yet specified are sequentially selected, and panel position specifying processing for the plurality of antenna panels is performed in parallel, it is possible to shorten the time required for the panel position specifying processing.

### Third Embodiment

A phased-array antenna according to this embodiment differs from those in the first embodiment and the second embodiment described above in that the antenna panels are grouped into a plurality of areas, and a plurality of reference panels are provided, one for each area. In the following, for the phased-array antenna according to this embodiment, a description of commonalties with the first embodiment and the second embodiment will be omitted, and the differences will be mainly described, using FIG. 8.

In this embodiment, by way of example, a description will be given of five groups, areas A to E, which are just some of the areas formed by dividing (grouping) the phased-array antenna into a plurality of areas. In FIG. 8, the antenna panels in the phased-array antenna are grouped into a plurality of areas, and a reference panel (first reference panel) or a provisional reference panel (second reference panel) is provided in each area. In this embodiment, a reference panel that serves as the primary reference (first reference panel) among all of the antenna panels is provided in area A, and provisional reference panels (second reference panels) that are provisional reference panels other than the first reference panel are provided in areas B to E.

In each of areas A to E, panel position candidates for the respective antenna panels are determined by a candidate determining unit, as described in the first embodiment. Specifically, in area A, the panel positions of the antenna panels are specified in turn starting from the reference panel, and in areas B to E, the panel positions of the antenna panels inside each area are provisionally specified, with the provisional reference panels provided in the respective areas serving as references.

At the boundaries between neighboring areas, with an area containing a reference panel or an area that is close to an area containing a reference panel defined as having superiority and an area that does not have superiority over a neighboring area being defined as having inferiority, the computational processing unit corrects the positions of the antenna panels in areas having inferiority on the basis of the neighboring reference panels having superiority. For example, the computational processing unit calculates a panel position correction (shift) A between area A and areas B to E. Once the computational processing unit calculates the correction A, it corrects the panel positions of the antenna panels in the respective areas provisionally specified in areas B to E on the basis of the correction Δ. By doing so, panel position information of the antenna panels in areas B to E is specified with reference to the panel position of area A. Once the computational processing unit specifies the panel positions of all antenna panels, it outputs them to the phase-shift setting unit.

The phase-shift setting unit sets the phase shifts on the basis of the specified (or corrected) panel position information and outputs them. Accordingly, because a plurality of reference panels (or provisional reference panels) are provided as references, and the panel position specifying processing for the grouped areas is performed in parallel in each area, it is possible to shorten the time required for the panel position specifying processing.

### REFERENCE SIGNS LIST

1 phased-array antenna
31 power source
32 instruction sending unit
40 detection unit
42 candidate determining unit
50 computational processing unit
51 position specifying unit
52 phase-shift setting unit

1. A phased-array antenna which has a configuration in which a plurality of antenna panels, having a plurality of antenna elements disposed in an array, are connected in the form of a straight line or a plane and which radiates a signal in a direction of arrival of a pilot signal transmitted from a receiving facility by controlling phases of signals input to and output from the individual antenna elements, the phased-array antenna comprising:
a detection unit that detects a phase of arrival of the pilot signal at each of the antenna panels on the basis of the pilot signal and a reference signal that is commonly transmitted to each of the antenna panels;
a position specifying unit that specifies a position of each of the antenna panels relative to a reference panel defined as the antenna panel for reference among the plurality of the antenna panels, on the basis of the phase of arrival and an angle of arrival between the direction of arrival of the pilot signal and the antenna panel; and
a phase-shift setting unit that sets respective phase shifts for the signals radiated from the individual antenna elements on the basis of information about the positions of the antenna panels specified by the position specifying unit.

2. A phased-array antenna according to claim 1, further comprising an instruction sending unit which is disposed at a prescribed height above a surface of the reference panel and which sends the reference signal to each of the antenna panels.

3. A phased-array antenna according to claim 1, further comprising:
an instruction sending unit which is disposed on a surface of at least one of the antenna panels of the plurality of the antenna panels and which sends the reference signal to each of the antenna panels; and
a control unit that controls the timing at which the reference signal is detected at the other antenna panels other than the antenna panel having the instruction sending unit according to a distance between the antenna panel having the instruction sending unit and the other antenna panels.

4. A phased-array antenna according to claim 1, wherein the position specifying unit comprises a selection unit that selects the next antenna panel at which the antenna panel positions is to be specified, and
the selection unit sequentially selects a plurality of the antenna panels neighboring the antenna panel where position determination is completed.

5. A phased-array antenna according to claim 1, wherein
a plurality of the reference panels are provided by dividing the antenna panels into a plurality of areas and having respective reference panels in the individual areas, with a reference panel serving as a primary reference among the plurality of the reference panels being defined as a first reference panel, and the reference panels other than the first reference panel being defined as second reference panels;
in each of the areas, the position specifying unit specifies the positions of the antenna panels on the basis of the reference panel in the area, and at boundaries between neighboring areas, with the area having the first reference panel or the area close to the area having the first reference panel defined as having superiority, and the area which does not have superiority over the neighboring area being defined as having inferiority, corrects the positions of the antenna panels in the area having inferiority on the basis of the neighboring reference panel having superiority.

6. A phase control method for a phased-array antenna which has a configuration in which a plurality of antenna panels, having a plurality of antenna elements disposed in an array, are connected in the form of a straight line or a plane and which radiates a signal in a direction of arrival of a pilot signal transmitted from a receiving facility by controlling phases of signals input to and output from the individual antenna elements, the phase control method for a phased array antenna comprising:
a first step of detecting a phase of arrival of the pilot signal at each of the antenna panels on the basis of the pilot signal and a reference signal that is commonly transmitted to each of the antenna panels;
a second step of estimating a position of each of the antenna panels relative to a reference panel defined as the antenna panels for reference among the plurality of the antenna panels, on the basis of the phase of arrival and an angle of arrival between the direction of arrival of the pilot signal and the antenna panel; and
a third step of setting respective phase shifts for the signals radiated from the individual antenna elements on the basis of information about the positions of the antenna panels specified in the second step.
